(19) United States
(12) Patent Application Publication
(10) Pub. No.: US 2004/0230144 A1
(43) Pub. Date: Nov. 18, 2004

(54) Foot Cleaning device

(76) Inventor: Gerhard Weinberger, Riedstadt (DE)

Correspondence Address: SQUIRE, SANDERS & DEMPSEY L.L.P, 600 HANSEN WAY, PALO ALTO, CA, 94304-1043, US

(21) Appl. No.: 10/845,254

(22) Filed: May 12, 2004

(30) Foreign Application Priority Data
May 13, 2003 (DE) 203 07 505.6

(51) Int. Cl. A61H 7/00

(52) U.S. Cl. 601/88; 601/114; 601/136

(57) ABSTRACT

The invention relates to a cleaning and/or massage device, comprising fixing means for fixing it in a stationary manner as an addition in the shower area, particularly suction cups, wherein the fixing means are designed to be so stable that foot cleaning is possible, and comprising a hydraulic drive which can be connected to a multiway valve of a water supply line and drives a brush in a rotating manner.

### DESCRIPTION

The invention relates to a foot-care device.

### FIELD OF THE INVENTION

Such devices are predominantly used to clean feet in small shower cubicles or for massage purposes. The prior art contains a large number of rotating brushes which are driven by water. Nevertheless, not all of these devices have fixing means which make it possible to fit such a brush as an addition in the cubicles. However, no device is known which has all the features of the invention, particularly the quiet operation, handling and dimensions.

### OBJECT OF THE INVENTION

The object of the invention is to provide a brush which allows it to be installed as an addition and which is cost-effective to produce.

### SOLUTION OF THE INVENTION

This object is achieved by the inventions having the features of the independent claims. Advantageous developments of the inventions are characterized in the dependent claims.

An aid to public health is thereby provided by virtue of the convenient overall thorough cleaning, massaging and disinfecting of the feet. For people with hip trouble, back pain, balance problems and also elderly and overweight people, the foot-care device facilitates foot hygiene and health.

People with standing jobs will appreciate the foot-care device.

By virtue of a multiway valve, the device is suitable for installation as an addition to all commercially available bathtubs and shower fittings. The foot-care device can also be installed in a permanent manner on account of the compact design and the possibility of being installed in an area of the shower cubicle that is not used very often (on the wall below the shower fitting).

There is the possibility of giving the foot-care device an external colour and design such that it can be added without any problems to any new commercially available series of fittings.

By virtue of the easy and simple handling of the fixing parts (hinged suckers) and by virtue of an articulation with handwheel, the foot-care device can be adjusted at any time in terms of height and angle without the need for a tool. The associated kit allows space-saving installation in virtually any existing shower system (wall installation and corner installation with height adjustment are conceivable).

By detaching the fixing parts (hinged suckers), the areas of the bathtub or shower cubicle that are hidden by the foot-care device can be cleaned in a hygienic and simple manner.

By adjusting the height and angle, the foot-care device is also suitable for cleaning and massaging the back.

The brush holder is made such that the brushes and massage rollers can be exchanged using one hand.

The holder adapter for the brushes and massage rollers, which is produced in various colours, serves to tailor it to the user's personal requirements.

The number on the holder adapter identifies the various degrees of hardness and facilitates selection for the desired intensity and the body region of the user that is to be cleaned.

It is possible to use the foot-care device in the late evening and early morning without any problems on account of its very quiet operation. This is achieved by the use of hard foam balls which are mounted on the rotor disc, and also by the stable design of the housing.

By virtue of the essentially round shape of the housing and the rounded edges, the risk of injury by the foot-care device is very low, even in the event of a fall.

The low torque and the low rotational speeds are achieved by the gearing on the power train and the installation of the flow restrictors.

The materials and components are selected such that, following detachment of the water supply line, the foot-care device can be cleaned by any domestic dishwasher.

The cleaning device according to the invention is connected to the bathtub or shower fitting preferably by a half-inch two-way valve with free flow and a commercial connection; the two outlets of the valve with likewise commercially available connections serve on the one hand for connection of the shower hose and on the other hand for connection of the metering unit. It is conceivable for the two-way valve and the metering unit to be produced together in one unit.

There is moreover an adjustment knob for metering the soap and a hand-operated pump for spraying the disinfectant, the soap being metered directly into the water supply line.

The metering unit is preferably provided with two different receptacles for one bottle of liquid soap or the like and one bottle of disinfectant (foot-cleaning agent), so that it is not possible for the two containers to be mixed up. The disinfectant is pumped via a capillary tube to a spraying nozzle incorporated in the foot-care device.

The metering unit has on the upper side the connection to the two-way valve and on the lower side the connection for the water supply to the foot-care device.

The water supply line is a flexible hose with an integrated capillary tube which has on the upper side a connection to the metering unit and on the lower end the connection for the foot-care device.

The pressure difference in the domestic water supply line of the individual regions or storeys can be levelled out by incorporating flow restrictors (seals having different internal diameters) in the upper connection of the water supply line to the metering unit.

The foot-care device consists of a round plastic housing with a diameter of preferably about 220 mm, in which there is a circular channel with a diameter of preferably about 200 mm and a cross section of preferably about 12 mm, on the upper part of which there is fitted a connection to the water supply line such that the water enters the channel at preferably 45°. The water is then preferably passed ⅔ of the way through the channel until it leaves through the openings in the exit tube, installed in the upper part, and moistens the brush or massage roller.

On the inner side of the channel there is a slot that is approximately 3 mm wide, in which a plastic disc rotates on an axle which is fitted in the centre of the rear housing.

For sealing between the channel slot and the rotating disc, use is made of a circumferential sealing tape that is preferably made of soft PVC, which sealing tape is pressed slightly by the water pressure and thus prevents excess pressure and water loss.

The rotation of the rotor disc is brought about by a number of hard foam balls which are placed on the plastic disc and driven by the water pressure through the circular channel.

A gearwheel, which is fitted in the centre of the rotor disc and runs on the same axle, drives two gearwheels of different size which are connected to one another and run on an axle which is fitted on the front housing.

These two gearwheels in turn drive a gearwheel on which there is permanently mounted the brush drive with the holder for the brushes or massage rollers.

The gearwheel and the brush holder are mounted on the same axle as the rotor disc, without being connected to one another.

The size of the gearwheels (gearing) is selected such that any injuries or accidents which may be caused by the speed or torque during operation are ruled out.

The brush holder has a metal clamp in order to prevent the brushes and massage rollers from simply falling out, and a single (standardized) shape ensures that no unchecked (lesser quality) brushes or massage rollers are used.

The brush has a precisely fitting adapter for holding and arresting it in the brush drive.

The shape of the brush is preferably similar to that of a poorly blown-up ball and has a diameter of about 200 mm and a brush length of 40-50 mm.

The massage roller is comparable to the brush in terms of size and shape, but has incorporated massage balls.

The fixing is preferably a device with 3 hinged suckers which can be attached to and detached from tiles, enamel, glass and all smooth surfaces without any problems.

The fixing device has an articulation with stop notches for determining the vertical angle of adjustment of the foot-care device in different degrees and a handwheel for loosening and arresting the articulation.

In a further embodiment, a tube that is about 1.6 m long and about 30 mm thick in diameter is used for permanent installation, said tube having four mounting brackets, two for wall installation and two for corner installation, and a device carrier for height adjustment and for holding the foot-care device.

### SHORT DESCRIPTIONS OF THE DRAWINGS

Hereinbelow, the invention will be explained in more detail with reference to examples of embodiments which are shown schematically in the figures. In the individual figures, the same references in each case refer to identical elements. In the figures:

FIG. 1 shows a front view of the brush according to the invention;

FIG. 2 shows a section through the brush according to the invention along A-A, in which the annular pressure chamber, the rotor balls, the rotor disc and the foot rest can be seen;

FIG. 3 shows a section through the brush according to the invention along B-B, in which the annular pressure chamber with the rotor balls can be seen, and also the arrangement of the gear train;

FIG. 4 shows a detail C along A-A, which shows the pressure chamber, the seal and the slot through which the rotor disc is passed;

FIG. 5 shows different brush shapes and fixing supports with retainers for the brushes;

FIG. 6 shows a plan view of a possible fixing bracket with suction cups;

FIG. 7 shows a side view of the fixing bracket with suction cups;

FIG. 8 shows different mountings of a fixing by means of a sliding tube, with corner installation being conceivable;

FIG. 9 shows the design of a metering unit;

FIG. 10 shows the connection hose;

FIG. 11 shows the front view of one embodiment of the brush according to the invention with 4 brushes;

FIG. 12 shows a section through one embodiment of the brush according to the invention with 4 brushes along A-A, in which the annular pressure chamber, the rotor balls, the rotor disc and the foot rest can be seen;

FIG. 13 shows a section through one embodiment of the brush according to the invention with 4 brushes along B-B, in which the annular pressure chamber with the rotor balls can be seen, and also the arrangement of the gear train; and

FIG. 14 shows a section through one embodiment of the brush according to the invention with 4 brushes along D-D, in which the arrangement of the gear train can be seen.

### DETAILED DESCRIPTION OF THE PREFERRED EMBODIMENT

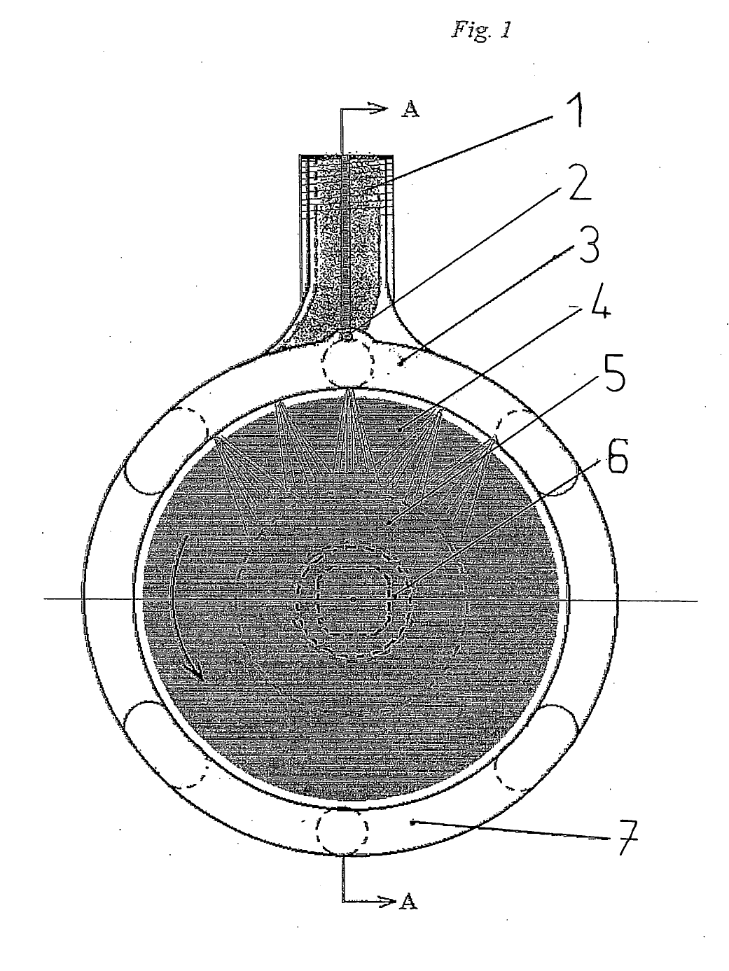

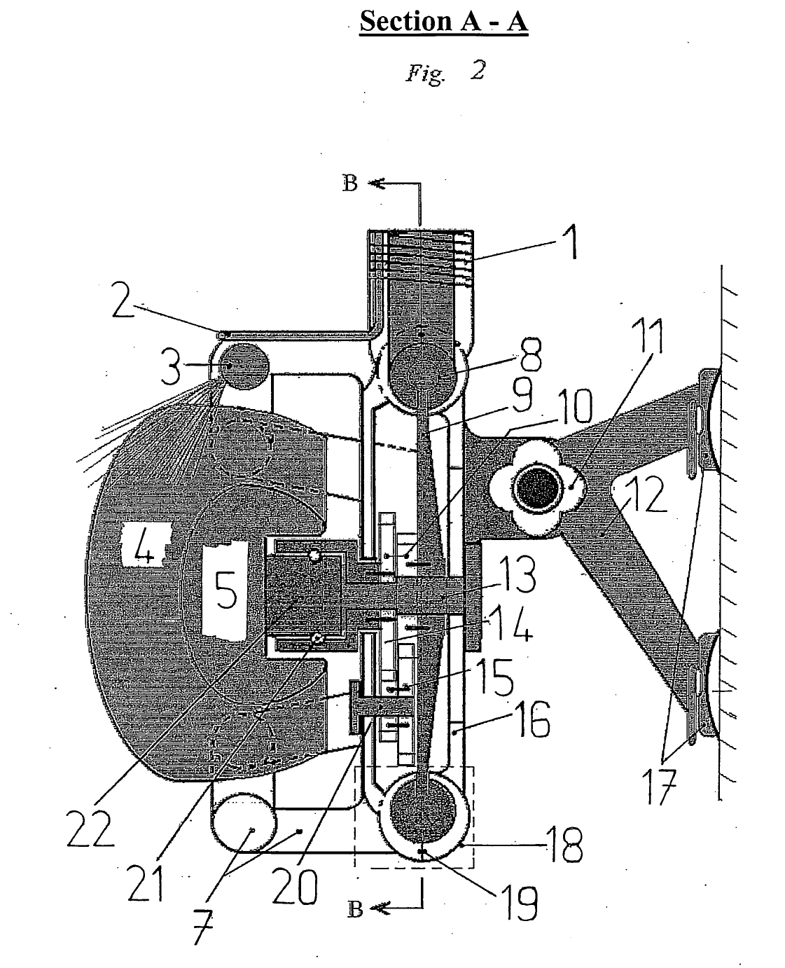

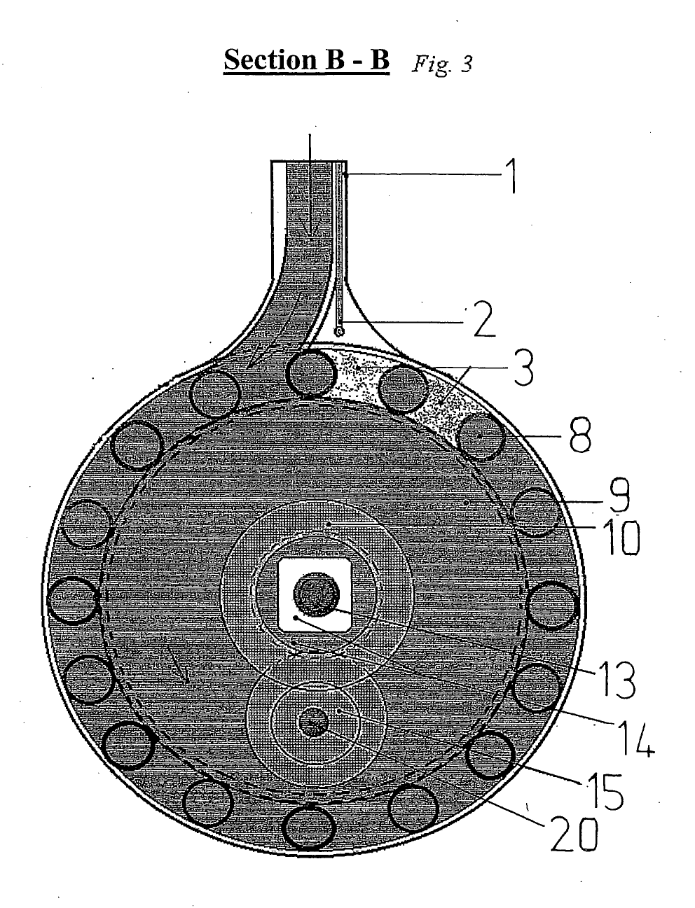

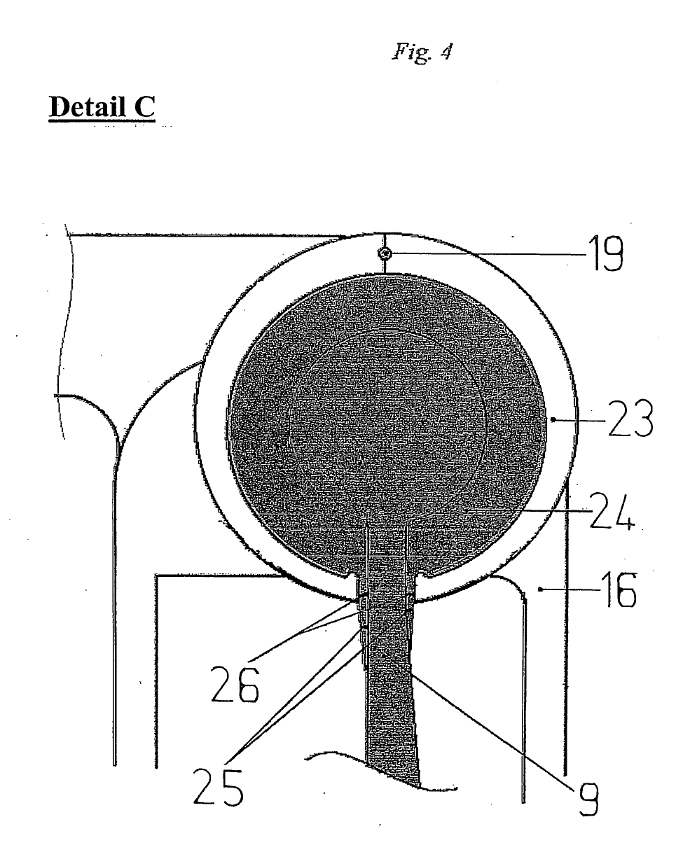

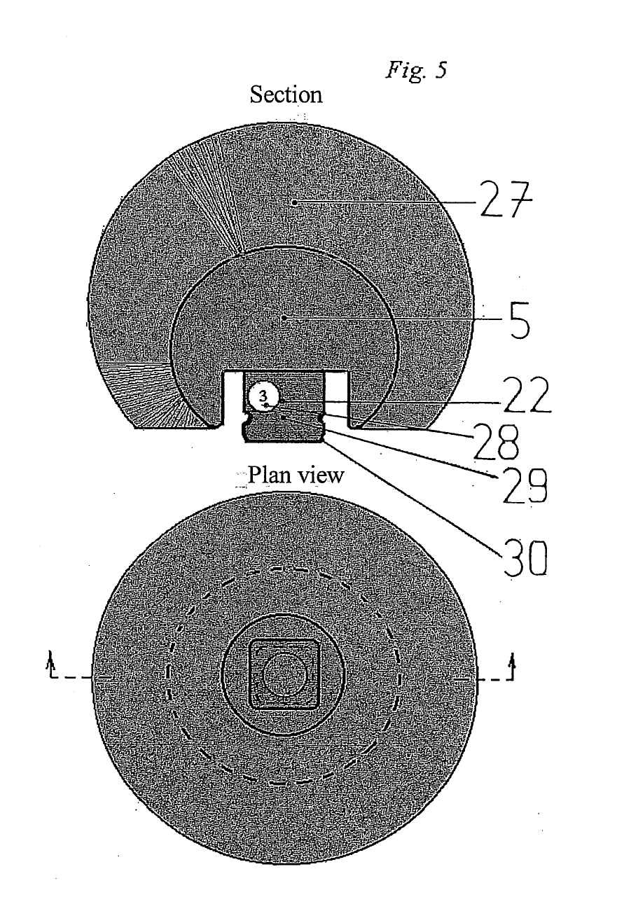

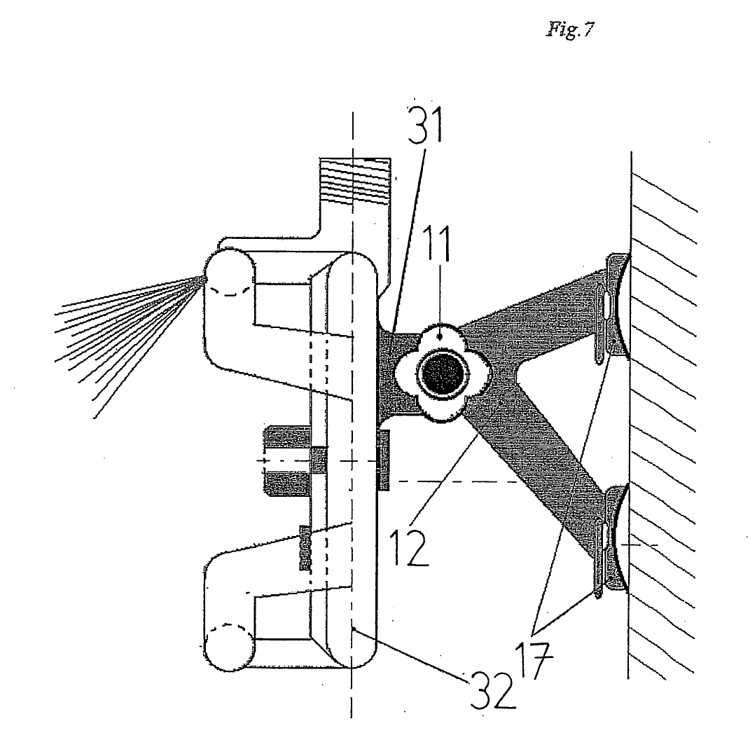

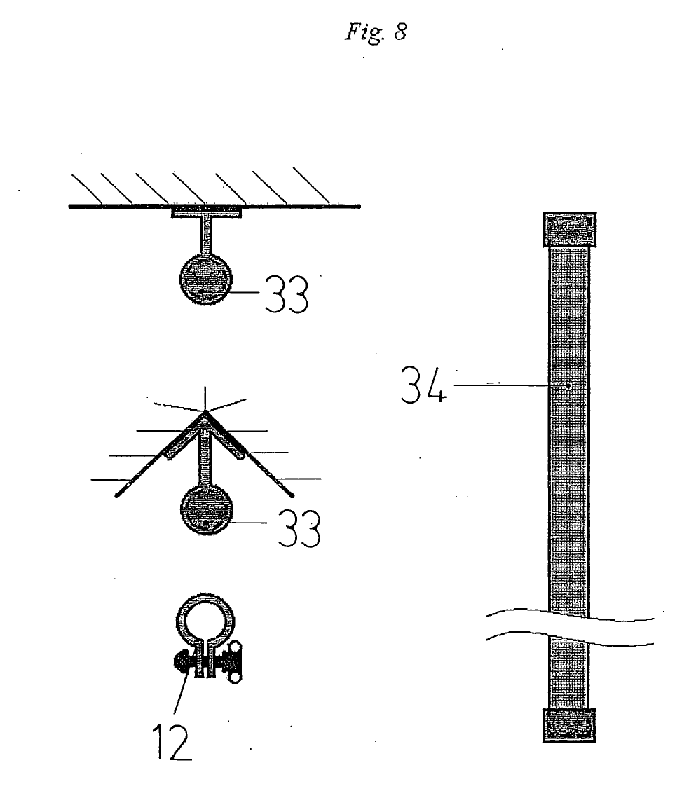

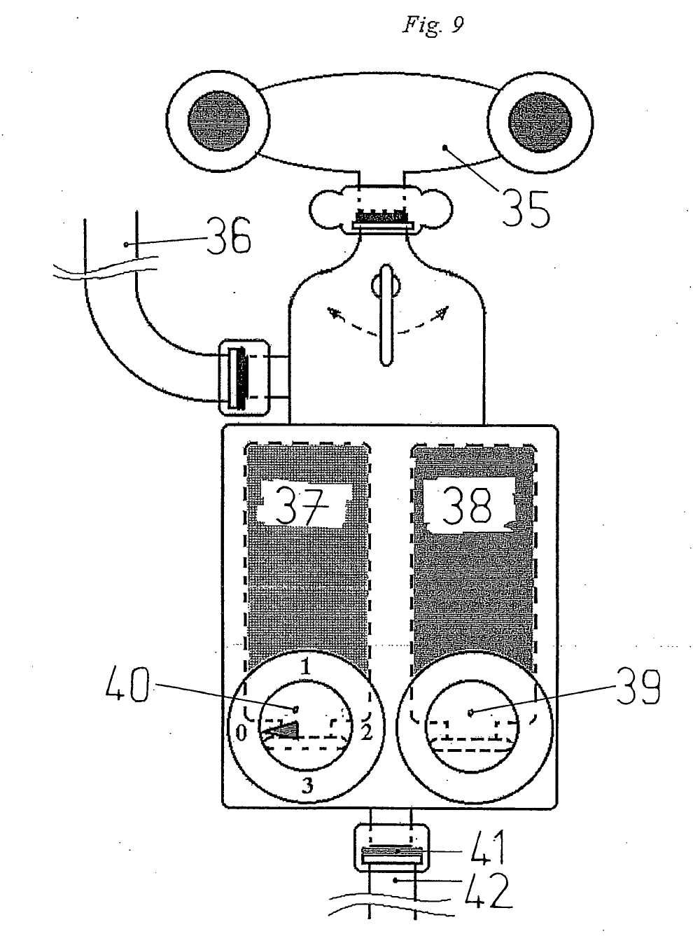

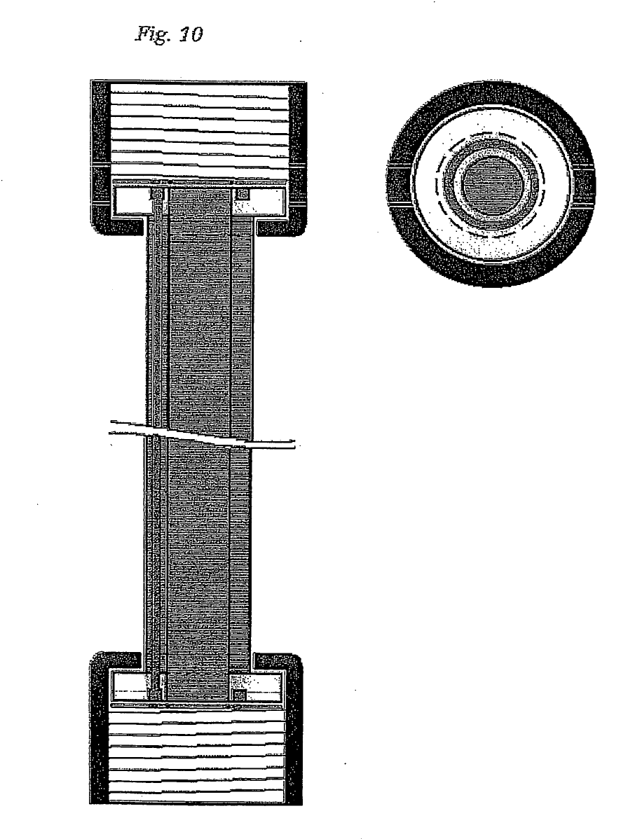

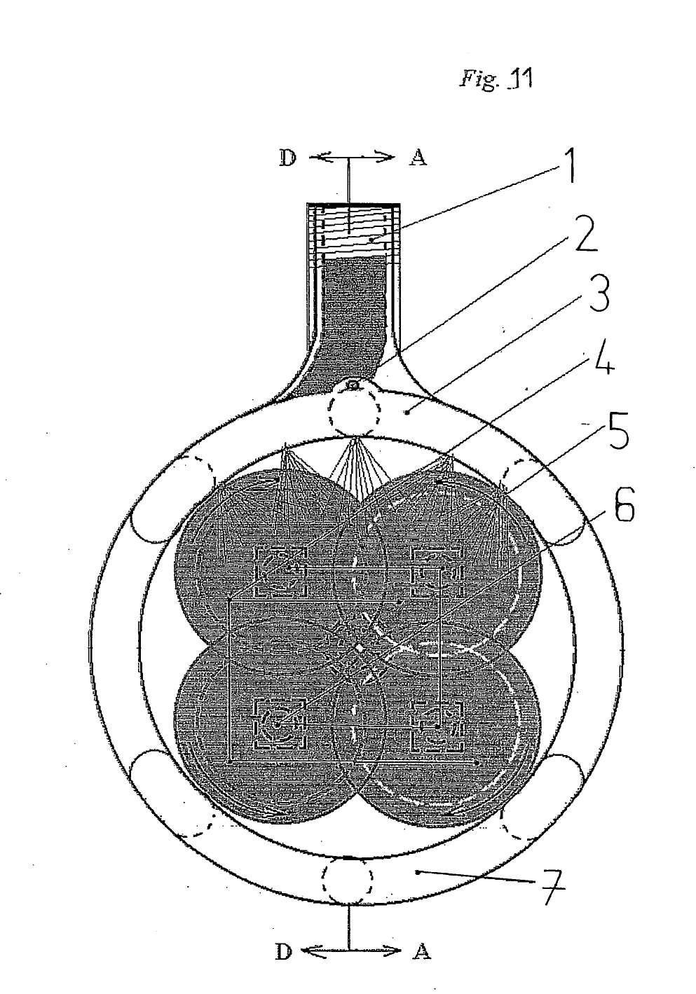

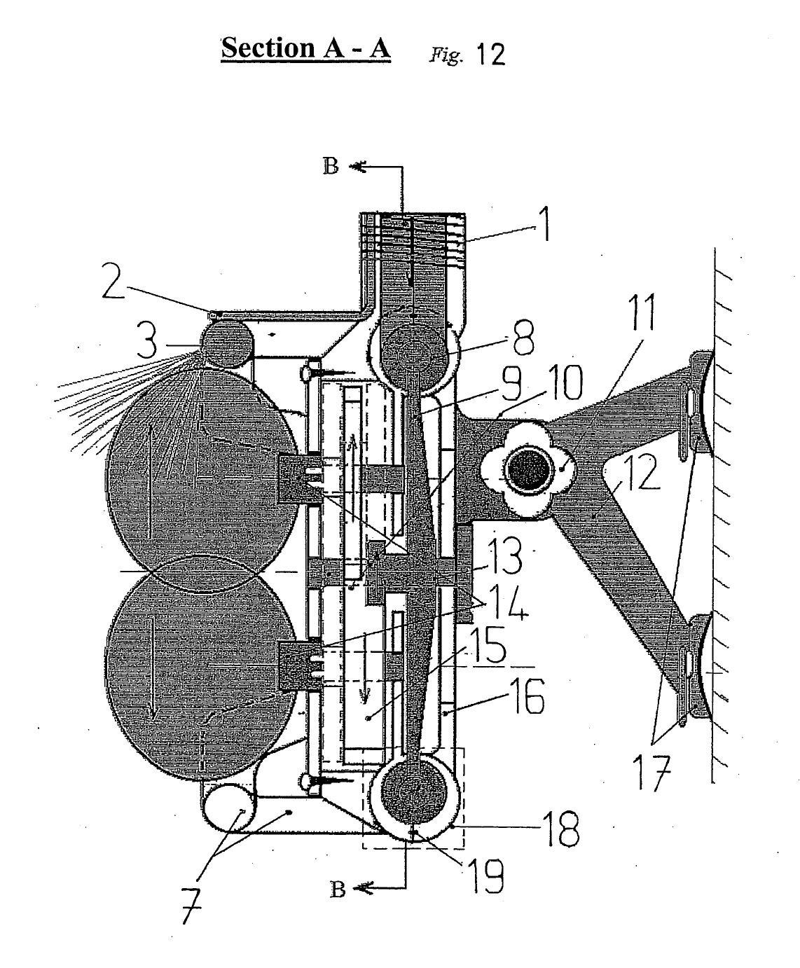

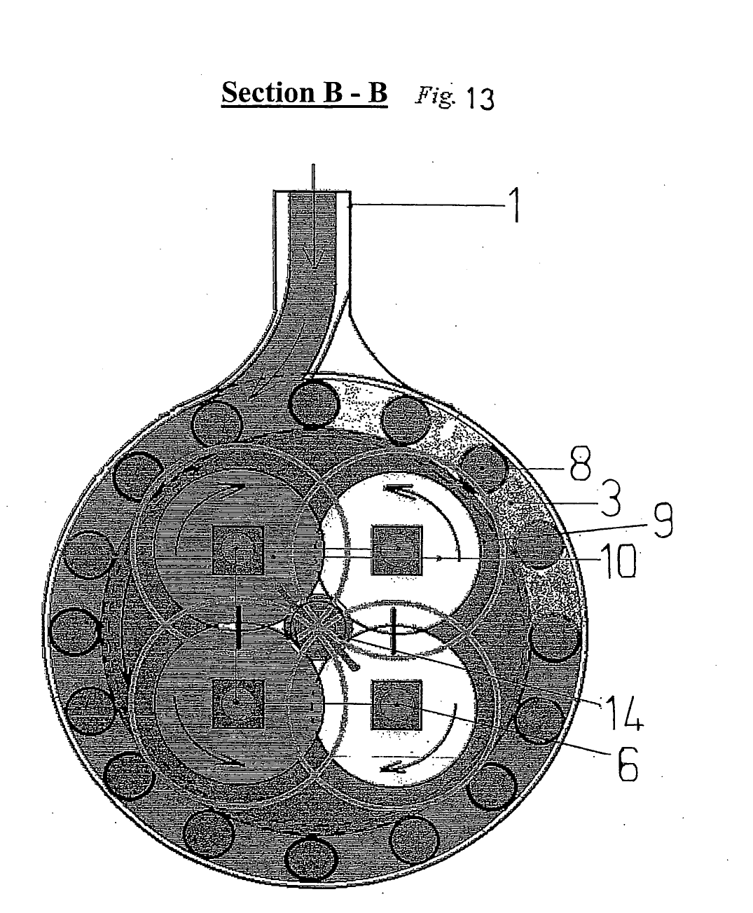

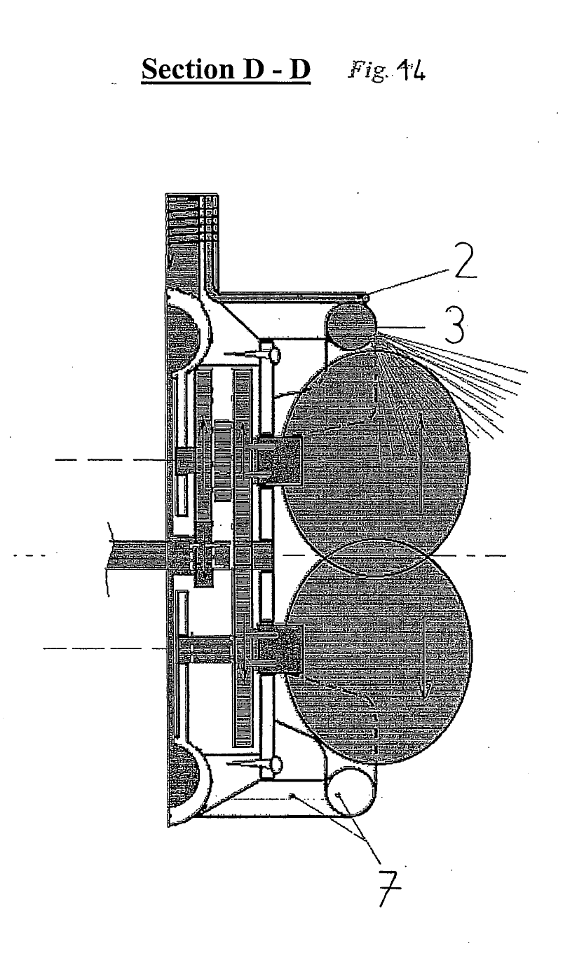

FIGS. 1 to 14 show two possible preferred embodiments in which different gear trains are selected. For instance, a reducing gear train is selected in order to improve the torque. Via the water supply connection 1, the water flows to the water outlet or exit tube 3, as a result of which the brush 4 is driven. The brush is arranged on the bristle carrier 5 which has a brush holder 6 which rotates around the central axle 13. In this case, the brush is held via a clamp 21 and a holder adapter 22. The stop 29 may be designed as a groove. A bevelled portion 30 at the end of the holder is used for easier installation.

The brush is driven via a rotor disc 9 which is provided with rotor balls 8. The latter act on gearwheels 10 and drive the brush 4 by deflecting the gear train for example via a front axle 20. The rotor balls rotate in a housing 16 which is provided with a seal 19, so that the balls form a closure in the channel 23. The balls are preferably designed as hard foam balls 24.

In order to prevent water from leaving the channel, shovel-shaped fans are provided which act as a pressure lock 26 and thus prevent water from leaving the channel. The brush head has different bristles 27 with different degrees of hardness 28.

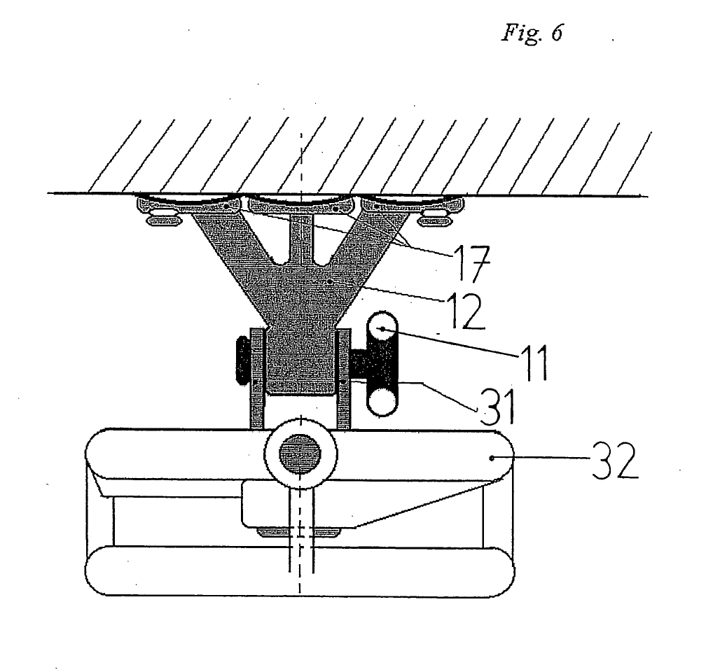

FIG. 6 shows an alternative housing carrier 31 for the device carrier 12, which housing carrier 31 bears the drive housing 32 and a further mounting 33.

A spraying nozzle 2 and a foot rest 7 are additionally provided, which serve for better cleaning. Hinged suckers 17 are provided for fixing to the wall. A handwheel for angle adjustment 11 is provided in order to determine the angle of the brush which is arranged on a device carrier.

A sliding tube 34 is used for the variable fixing of the device.

The fitting 35 serves to control the flow of drive fluid. A shower is connected via the shower hose 36. The flow control 41 is used to produce a connection to the foot cleaner 42.

A container for soap 37 and a container for cleaning agent 38 serve to provide cleaning agents which are transported to the exit tube 3 via a pump 39 and a metering unit 40.

### LIST OF REFERENCES

1 water supply connection

2 spraying nozzle

3 water outlet/exit tube

4 brush

5 bristle carrier

6 brush holder

7 foot rest

8 rotor ball

9 rotor disc

10 gearwheels

11 handwheel for angle adjustment

12 device carrier

13 centre axle

14 drive

15 double gearwheel

16 housing

17 hinged sucker

18 detail C

19 seal

20 front axle

21 clamp

22 holder adapter

23 channel

24 hard foam ball

25 fan (shovel)

26 pressure lock

27 bristles

28 degree of hardness

29 stop

30 bevelled portion

31 housing carrier

32 drive housing

33 2 mountings

34 sliding tube

35 fitting

36 shower hose

37 container for soap

38 container for cleaning agent

39 pump

40 metering unit

41 flow control

42 connection to the foot cleaner

1. Cleaning and/or massage device
comprising fixing means for fixing it in a stationary manner as an addition in the shower area, particularly suction cups, wherein the fixing means are designed to be so stable that foot cleaning is possible,
comprising a hydraulic drive which can be connected to a multiway valve of a water supply line and drives a brush in a rotating manner.

2. Cleaning and/or massage device according to the preceding claim 1, wherein at least one outlet for a cleaning agent and/or disinfectant in the region of the brush; and/or in that there is at least one receptacle and/or container for a cleaning agent and/or disinfectant.

3. Cleaning and/or massage device according to the preceding claim 1, characterized in that use is made of a sliding rail for fixing to a wall, on which sliding rail the rotating brush can be arrested in a variable manner, wherein the sliding rail can be fixed to the wall preferably by means of suction cups; and/or in that the fixing means are designed such that a corner installation is possible.

4. Cleaning and/or massage device according to the preceding claim 3, characterized in that hinged suckers are used.

5. Cleaning and/or massage device according to the preceding claim 3, characterized by the fixing via an articulation with possibilities for stopping, particularly with stop notches.

6. Cleaning and/or massage device according to the preceding claim 1, wherein a foot rest is arranged in the region of the brush, particularly around the rotating brush, such that the feet can be supported during the cleaning process.

7. Cleaning and/or massage device according to the preceding claim 1, characterized in that there are brush holding means which are designed such that the brushes can be exchanged, wherein use is preferably made of a metal clamp system so that different shapes of brushes can be used.

8. Cleaning and/or massage device according to the preceding claim 1, characterized in that there are valves for controlling the pressure and speed.

9. Cleaning and/or massage device according to the preceding claim 1, characterized in that use is made of a form of drive according to one or more of the following claims.

10. Hydrostatic drive, particularly for a rotating brush
comprising an annular pressure chamber which can be filled with liquid under pressure and has an outlet,
comprising at least one rotor ball which is arranged in a sealing manner in the pressure chamber,
comprising an axle on which a connection means, particularly a rotor disc, is arranged such that it can rotate, said connection means being connected to the rotor balls,
comprising a brush which is effectively connected to the connection means such that the surrounding rotor balls transmit a movement to the brush.

11. Hydrostatic drive according to the preceding hydrostatic drive claim 10, characterized by a slot in the pressure chamber through which the connection means is passed into the pressure chamber.

12. Hydrostatic drive according to the preceding hydrostatic drive claim 11, characterized by a seal which seals the slot but is nevertheless designed such that it is possible to pass the connection means through in a rotating manner, wherein the seal is preferably designed as a fan in order to form a pressure lock.

13. Hydrostatic drive according to the preceding hydrostatic drive claim 10, characterized by a gear train which is arranged between the brush and the connection means, wherein the gear train should produce as high a torque as possible.
